(19) United States
(12) Patent Application Publication
(10) Pub. No.: US 2017/0111855 A1
(43) Pub. Date: Apr. 20, 2017

(54) ACCESS POINT SELECTION DEPENDING ON SIGNAL STRENGTH AND LOAD

(71) Applicant: KABUSHIKI KAISHA TOSHIBA, Minato-ku (JP)

(72) Inventors: Fengming CAO, Bristol (GB); Zhong FAN, Bristol (GB)

(73) Assignee: KABUSHIKI KAISHA TOSHIBA, Minato-ku (JP)

(21) Appl. No.: 15/300,546

(22) PCT Filed: Mar. 31, 2014
(86) PCT No.: PCT/GB2014/051013

§ 371 Date: Sep. 29, 2016

(51) Int. Cl. H04W 48/20; H04W 24/08; H04B 17/336; H04L 12/26

(52) U.S. Cl. CPC H04W 48/20; H04L 43/0882; H04W 24/08; H04B 17/336

(57) ABSTRACT

A user device including a receiver for establishing a communications link with a wireless network and an access point selecting module for selecting an access point to use in establishing the communications link, the access point selecting module configured to: identify a plurality of access points within range of the user device and for each one of the identified access points; determine a maximum rate of data throughput that is achievable if using the access point to connect to the network; determine the value of a load parameter for the access point, wherein the value of the load parameter is indicative of apparent demand for resources that the access point is currently experiencing; determine a relative potential capacity of the access point by weighting the maximum rate of data throughput by the load parameter and select an access point to connect to the wireless network.

### FIELD

Embodiments described herein relate generally to methods for selecting an access point to serve as a connection point for connecting a user device to a wireless network.

### BACKGROUND

In recent years, wireless networks, or WiFi networks, have become increasingly common, in part due to the popular use of smart phones and other personal computing devices, with over one billion chipsets being sold every year. As the use of such devices continues to grow, some wireless networks are becoming extremely dense and heavily loaded, which means that neighbouring access points (APs) must be positioned closer together and serve more users.

In a conventional system, when a user device signals its desire to connect to a network, the device will scan the signals from access points located in the vicinity and choose to connect to the AP that has strongest received signal. However, using the received signal strength (RSS) to determine which access point to connect to can cause traffic aggregation at certain access points, particularly where users are unevenly distributed between those access points, leading to congestion and performance degradation.

### BRIEF DESCRIPTION OF FIGURES

Embodiments of the invention will now be described by way of example with reference to the accompanying drawings in which:

FIG. 1 shows an example of an office environment in which different user devices connect to a wireless network via different access points;

FIG. 2 shows steps carried out by a user device when selecting an access point to connect to a wireless network, in a method according to an embodiment;

FIG. 3 shows steps carried out by a user device when selecting an access point to connect to a wireless network, in a method according to an embodiment;

FIG. 4 shows steps carried out by a user device when selecting an access point to connect to a wireless network, in a method according to an embodiment;

FIG. 5 shows an example how different user devices may connect to different access points in accordance with embodiments described herein; and

FIG. 6 shows an example of a user device according to an embodiment described herein.

### DETAILED DESCRIPTION

According to a first embodiment, there is provided a user device comprising:
a receiver for establishing a communications link with a wireless network; and
an access point selecting module for selecting an access point to use in establishing the communications link, the access point selecting module being configured to:
(i) identify a plurality of access points within range of the user device;
(ii) for each one of the identified access points:
   evaluate the signal to noise ratio achievable by the user device if using the access point to connect to the network;
   determine, based on the signal to noise ratio, a maximum rate of data throughput that is achievable if using the access point to connect to the network;
   determine the value of a load parameter for the access point, wherein the value of the load parameter is indicative of the apparent demand for resources that the access point is currently experiencing;
   determine a relative potential capacity of the access point, wherein the relative potential capacity is determined by weighting the maximum rate of data throughput that is achievable by the load parameter, such that the relative potential capacity increases as the apparent demand for resources decreases; and
(iii) select an access point to connect to the wireless network.

In some embodiments, the load parameter is a number of user devices connected to the access point. In some embodiments, the load parameter is an interval between receiving successive beacon signals from the access point at the user device.

In some embodiments, when selecting an access point to connect to the wireless network, the access point selecting module is configured to identify the access point offering the highest achievable rate of data throughput and the access point having the highest relative potential capacity; and in the event that the access point offering the highest achievable rate of data throughput and the access point having the highest relative potential capacity are the same, to select that access point for connecting to the network.

In some embodiments, when selecting an access point to connect to the wireless network, the access point selecting module is configured to identify the access point offering the highest achievable rate of data throughput and the access point having the highest relative potential capacity; and in the event that the access point offering the highest achievable rate of data throughput is different from the access point having the highest relative potential capacity, the access point selecting module is configured to:
determine whether the user device is in an edge region of a cell served by the access point offering the highest achievable rate of data throughput and if so, to select the access point having the highest relative potential for connecting to the network, otherwise to select the access point offering the highest achievable rate of data throughput.

In some embodiments, when determining whether the user device is in an edge region of the cell, the access point selecting module is configured to compare the strength of the signal received from the access point offering the highest achievable rate of data throughput with the average signal strength received by user devices currently connected to that access point.

In some embodiments, when comparing the strength of the signal received from the access point offering the highest achievable rate of data throughput with the average signal strength received by user devices currently connected to that access point, the user device is configured to first weight the average received signal strength with a threshold parameter, whose value is between 0 and 1.

In some embodiments, in the event that the user device is currently connected to the network via a particular access point, the access point selecting module is configured to determine if the particular access point is the same as the access point having the highest relative potential capacity and if so, to select that access point for remaining connected to the network.

In some embodiments, in the event that the particular access point to which the user device is currently connected is not the one having the highest relative potential capacity, the user device is configured to determine whether a further switching criterion is met and if so, to switch to the access point having the highest relative potential capacity. In some embodiments, the switching criterion is met when the ratio of the signal strength that the user device is receiving from the access point to which it is currently connected and the average signal strength received by user devices currently connected to that access point is below a threshold. In some embodiments, the threshold is determined by generating a random number.

In some embodiments, the user device is configured to repeat steps (i) to (iii) at intervals having a predetermined duration. In some embodiments, the user device is configured to repeat the steps (i) to (iii) in response to a change in the network environment. A change in the network environment may include a change in the geographic location of the user device and/or a change in the number of user devices connected to the access points that are within range.

According to a second embodiment, there is provided an access point for facilitating connection of one or more user device(s) to a wireless network, the access point being configured to:
receive a measure of the strength of the signal being received at each user device that it is currently serving;
compute the average strength of the received signals; and
broadcast an indication of the average strength to user devices that are presently within range of the access point.

In some embodiments, the access point is further configured to broadcast the number of user devices that it is presently serving to the user devices that are within range.

In some embodiments, the access point is configured to broadcast a threshold parameter with value between 0 and 1 and the average strength or to broadcast a value of the average strength when weighted by the threshold parameter.

According to a third embodiment, there is provided a system comprising an access point according to the second embodiment and one or more user devices according to the first embodiment.

According to a fourth embodiment, there is provided a method for selecting an access point to serve as a connection point for connecting a user device to a wireless network, the method comprising:
(i) identifying a plurality of access points within range of the user device;
(ii) for each one of the identified access points:
   evaluating the signal to noise ratio achievable by the user device if using the access point to connect to the network;
   determining, based on the signal to noise ratio, a maximum rate of data throughput that is achievable if using the access point to connect to the network;
   determining the value of a load parameter for the access point, wherein the value of the load parameter is indicative of the apparent demand for resources that the access point is currently experiencing;
   determining a relative potential capacity of the access point, wherein the relative potential capacity is determined by weighting the maximum rate of data throughput that is achievable by the load parameter, such that the relative potential capacity increases as the apparent demand for resources decreases; and
(iii) selecting an access point to connect to the wireless network.

According to a fifth embodiment, there is provided a non-transitory computer readable storage medium comprising computer executable instructions that when executed by a computer will cause the computer to carry out a method according to the fourth embodiment.

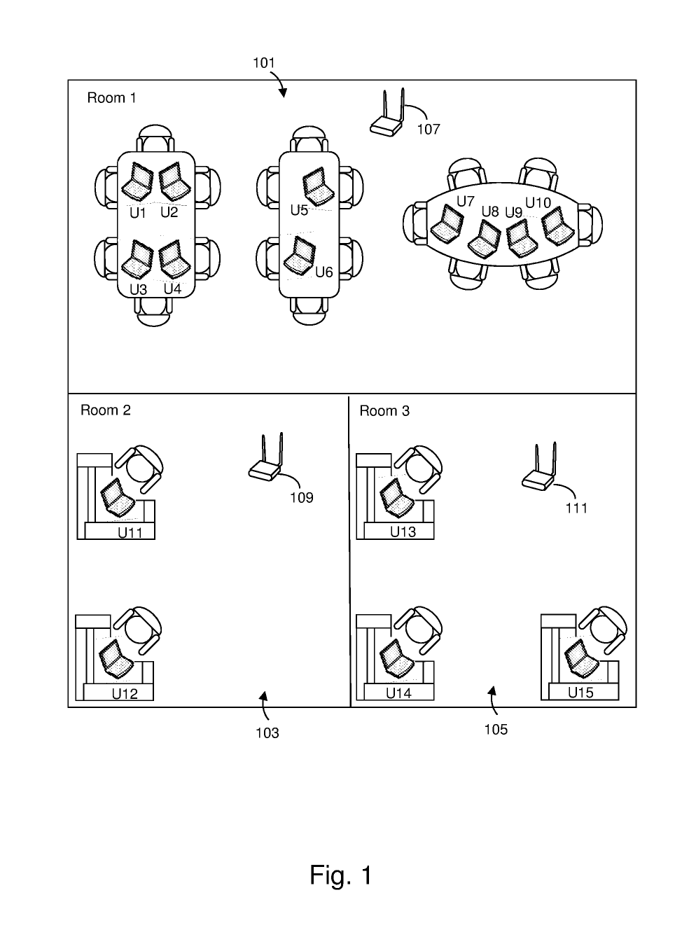

FIG. 1 shows an example of how traffic aggregation may occur when a conventional method is used for selecting access points to connect to a wireless network. In this FIG. 1, an office building is shown to comprise 3 rooms: a meeting room 101 and two smaller offices 103, 105, each one of which has its own access point for connecting a wireless network. Users U1-U10 are present in the meeting room 101, each having a respective laptop computer that they wish to connect to the network. Similarly, users U11 and U12 are located in the first office 103 and users U13-U15 are located in the second office 105. Assuming that each user connects to the access point that offers the highest signal strength, users U1-U10 will each connect to the access point 107 in the meeting room, whilst users U11 and U12 connect to access point 109 and users U13-U15 connect to the access point 111. Thus, the access point 107 in the meeting room will be required to serve all the laptops in that room, while the access points 109, 111 in the smaller offices serve fewer laptops. Consequently, the access point 107 in the meeting room will be overloaded, whilst the access points 109, 111 in the offices will have additional capacity that fails to be utilised.

Embodiments described herein provide a user-centric load balance method, in which each user independently decides to associate with an access point, taking into account one or more of the link quality, the load conditions of access points and the location of the user. The user may be a new addition to the network, or an existing user that is already connected to the network through a first access point and seeks to evaluate whether to switch to a different access point. Embodiments can help to optimize the overall system throughput by increasing the user as well as access point throughput. The throughput can be increased with minimal signalling change and without the need for inter-access point coordination.

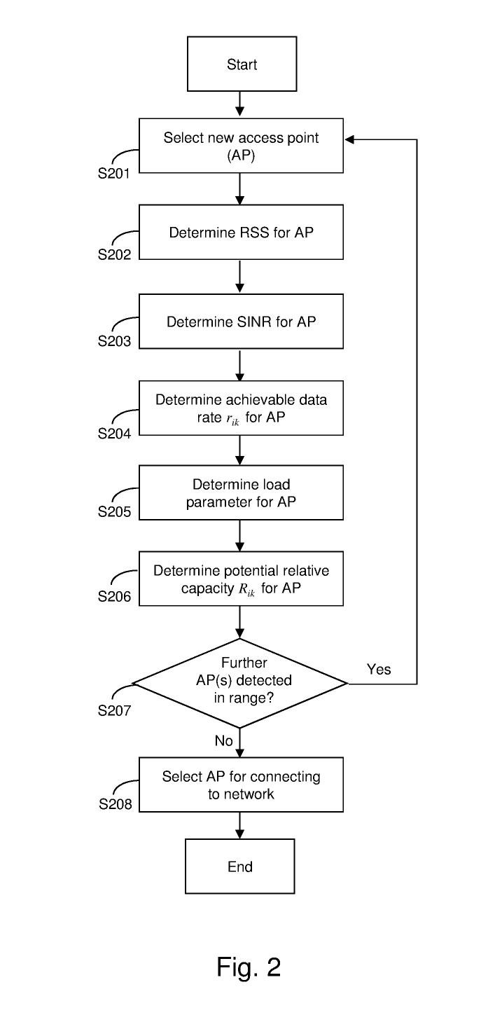

FIG. 2 shows the steps carried out by a user device when selecting an access point to connect to a wireless network, in a method according to an embodiment. Here, it is assumed that there are I access points within range of the user device, where each access point serves a cell comprising a set of active user devices Ωᵢ, and Nᵢ=|Ωᵢ| is the number of active user devices being served by the i^{th} access point. The total number of active user devices N will, therefore, be given by N=Σᵢ₌₁^{I}Nᵢ. For a given access point i, the parameter S_{i,n} denotes the received signal strength (RSS) at the n^{th} user device being served by that access point, where n∈Ωᵢ.

Referring to FIG. 2, the method commences in step S201 with a user device k identifying an access point that is in range. The user device k measures the strength of the signal RSS Sᵢₖ that it is receiving from the access point (step S202) and determines the signal to interference plus noise ratio SINRᵢₖ for signals received from that access point (step S203).

In step S204, the user device estimates the achievable data rate rᵢₖ for the access point, where rᵢₖ is determined based on the signal to interference plus noise ratio. For example, the achievable data rate may be determined as a function ƒ(SINRᵢₖ), where the function ƒ comprises a lookup table or a capacity formula.

Next, in step S205, the user device determines a value of a load parameter for the access point. The load parameter may be any parameter that is indicative of the apparent demand for resources (e.g. the demand for bandwidth for uploading and/or downloading data to and from the network) that the access point is currently experiencing from other user devices that are currently connected to the network via the access point. The user device may determine the value of the load parameter by its own or through the control signals received from the access point.

In one example, the load parameter is the actual number of user devices N being served by the access point i. The number of user devices Nᵢ currently being served by the access point may be broadcast as part of the control signalling that the access point transmits. In another example, the load parameter may be defined by an interval Tᵢₖ, where T ᵢₖ defines the average interval between receiving successive beacon signals from the access point i at the user device k. The access point will typically transmit beacon signals at predetermined intervals. However, in the event that the access point is busy receiving transmissions from user devices, the channel on which the beacon signal is to be transmitted may not be available and the access point must, therefore, delay sending the beacon signal until the channel becomes available again (this is particularly true for networks using e.g. a CSMA contention based protocol). Thus, as the number of user devices being served by the access point increases, the interval Tᵢₖ will also increase, as there will be a greater chance that at any one moment in time the channel on which the beacon signal is to be sent will be unavailable. The interval Tᵢₖ may be measured by the user device itself, or alternatively it may be measured by the access point and transmitted to the user devices within its range.

In step S206, the user device uses the load parameter to determine a potential relative capacity Rᵢₖ for the access point (step S206). The potential relative capacity is, in effect, a measure of the achievable data rate when taking into account the demand placed on the access point by the other user devices that the access point is currently serving. The potential relative capacity may be determined, for example, as a ratio of the achievable data rate to the number of users that the access point serves (with or without taking into account the user k), or as a ratio of the achievable data rate to the average interval Tᵢₖ between successive beacon signals transmitted from the access point, i.e:

$${R}_{ik} = \frac{{r}_{ik}}{{N}_{i} + 1} or {R}_{ik} = \frac{{r}_{ik}}{{N}_{i}} or {R}_{ik} = \frac{{r}_{ik}}{{T}_{ik}} .$$

Having determined the potential relative capacity for the access point, the user device determines if there are other access points in range that serve as alternative points for accessing the wireless network (step S207). In the event that there are other access points in range, the user device proceeds to repeat the same steps S201-S206 for each of those access points. Once all available access points have been identified and the potential relative capacity of each one has been established, the device proceeds to select an access point to connect to the network (step S208).

In some embodiments, when selecting an access point to use to connect to the network, the connection status of the user device may be taken into consideration. As will be discussed below, the method may proceed differently depending on whether the user device is currently connected to the network via a particular access point, or whether the user device is not connected because the user device has just powered on, or because a previous connection has been lost, for example.

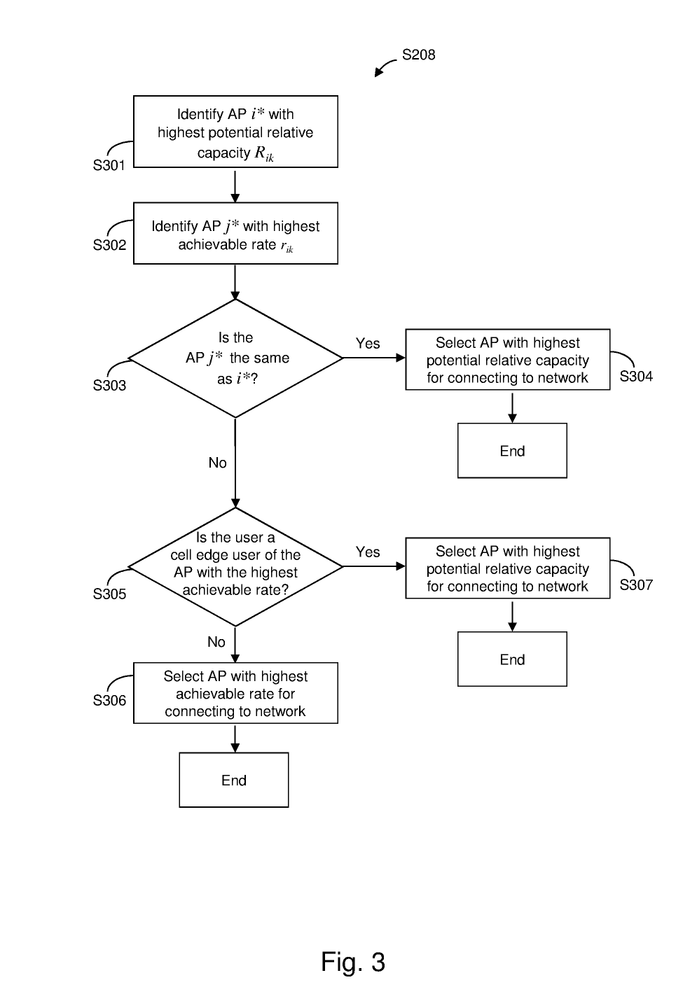

FIG. 3 shows an example of how step S208 of FIG. 2 may be implemented in the event that the user device is not currently connected to a particular access point. Here, having determined the potential relative capacity of all access points in range, the user device k determines the access point with the highest potential relative capacity as i*=argmaxᵢ Rᵢₖ (step S301) and also determines the access point that can provide the highest achievable data rate j*=argmaxᵢrᵢₖ. In step S303, the user device determines whether the access point offering the highest achievable data rate is the same as that with the highest potential relative capacity; if so, the user device selects that access point for connecting to the network (Step S304). If not, the method proceeds to Step S305, in which the user device determines whether it is located in a cell edge region of the access point j* offering the highest achievable data rate.

A number of methods may be employed in step S305 to determine if the user device is a cell edge user of the access point j*. One method that may be used is to compare the signal strength received by the user device with the average signal strength Sᵢ received by the user devices currently being served by that access point, where Sᵢ is given by:

$${S}_{i} = \frac{Σ n ∈ {Ω}_{i} {S}_{i , n}}{{N}_{i}} .$$

In practice, an access point will be able to determine the average received signal strength Sᵢ through knowledge of the actual received signal strength S_{i,n} at each of the user devices in the set Ωᵢ that the access point is serving. The access point may acquire this knowledge either from feedback from those user devices, or through uplink transmitted signal estimation. Once the access point has calculated the value of Sᵢ, it may then broadcast this value to user devices that are within range, as part of its control signalling.

Having received the value of Sᵢ from the access point, the particular user device k may initialise a parameter β, whose value is selected as being between 0 and 1, and compare the signal strength Sⱼ*ₖ that the user device k is receiving from the access point j* with the percentile of the average received signal strength β×Sⱼ*, where β×Sⱼ* can be understood to define the minimum signal strength that a user device k must receive from the access point j*, in order to be considered a cell edge user. So, for example, if the received signal strength at the user device Sⱼ*ₖ<β×Sⱼ* the user device k can be defined as being a cell edge user of the access point j*.

In some embodiments, the access point itself may initialise the parameter β and broadcast its value (or the value of β×Sⱼ*) to the user devices through the control signalling. A user device may then determine if it is cell edge user or not by comparing the strength of the signal received from the access point Sⱼ*ₖ with the value β×Sⱼ* in order to determine whether or not Sⱼ*ₖ<β×Sⱼ*.

In the event that the user is determined not to be a cell edge user, the user device k selects the access point j* for connecting to the network (Step S306). If the user device k determines that it is a cell edge user of the access point j*, then it selects the access point with the highest potential relative capacity for connecting to the network (Step S307).

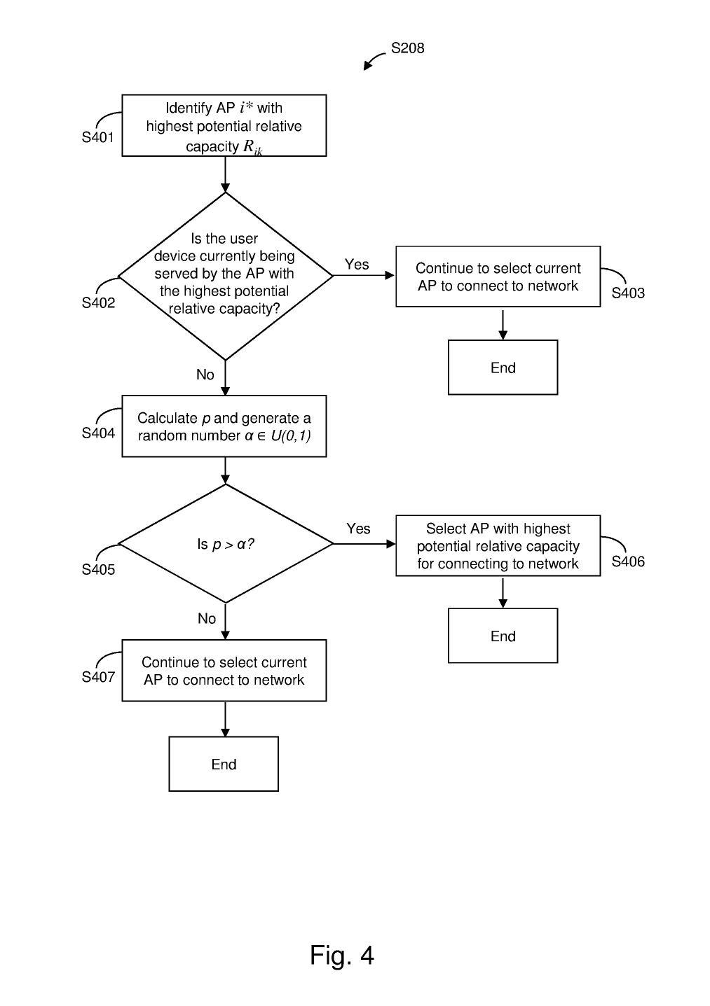

An embodiment will now be described in which the user device is currently connected to the network via a particular access point access point m, but seeks to determine whether a better connection is available using a different access point. Here, step S208 of FIG. 2 can be implemented as shown in the flow-chart of FIG. 4. In this instance, the user device k identifies the access point that can provide the highest potential relative capacity by i*=argmaxᵢRᵢₖ, where the potential relative capacity can be calculated, for example, with rᵢₖ and Nᵢ as

$${R}_{ik} = \frac{{r}_{ik}}{{N}_{i}}$$

if i=m, otherwise

$${R}_{ik} = \frac{{r}_{ik}}{{N}_{i} + 1} , or {R}_{ik} = \frac{{r}_{ik}}{{T}_{ik}}$$

(step S401).

In step S402, the user device k determines whether the access point i* having the highest potential relative capacity is the same access point m to which the user device is currently connected. If so, the user device elects to stay connected to the access point m (step S403). In the event that the access point i* offering the highest potential relative capacity is different from the access point m to which the user device is currently connected, the user device will choose to connect to the access point i* by determining if a switching criterion is met. In the present example, this comprises computing a value p, where p is defined to vary inversely with the strength of the signal received from the current access point m; that is, in the event that the strength of the signal being received from the current access point m is high, the value of p will be lower than the case in which the user device is only receiving a weak signal from the access point. The value of p may be determined, for example, as:

$$p = \frac{{S}_{m}}{{S}_{mk} + {S}_{m}}$$

where Sₘ is the average received signal strength for user devices currently being served by the access point m and Sₘₖ is the received signal strength from the access point m for the user device k.

As shown in step S404 of FIG. 4, in one example, determining the switching criterion further comprises generating a random number α, where α is between 0 and 1. The values of p and are compared (step S405) and if p>α, the user device will connect to the access point i* identified as having the highest potential relative capacity (Step S406). In the event that p≦α, the user device will choose to remain connected via its current access point m (Step S407).

The user device k may continue to scan the surrounding access points and repeat the steps of the present embodiment at certain intervals to check if there are any other access points that can provide a preferable access point for connecting to the network. For example, the user device may scan the signalling from surrounding access points and its serving access point either at predetermined intervals, or in response to a trigger event, such as detecting a change in the number of users that are being served by the access point to which the device is currently connected.

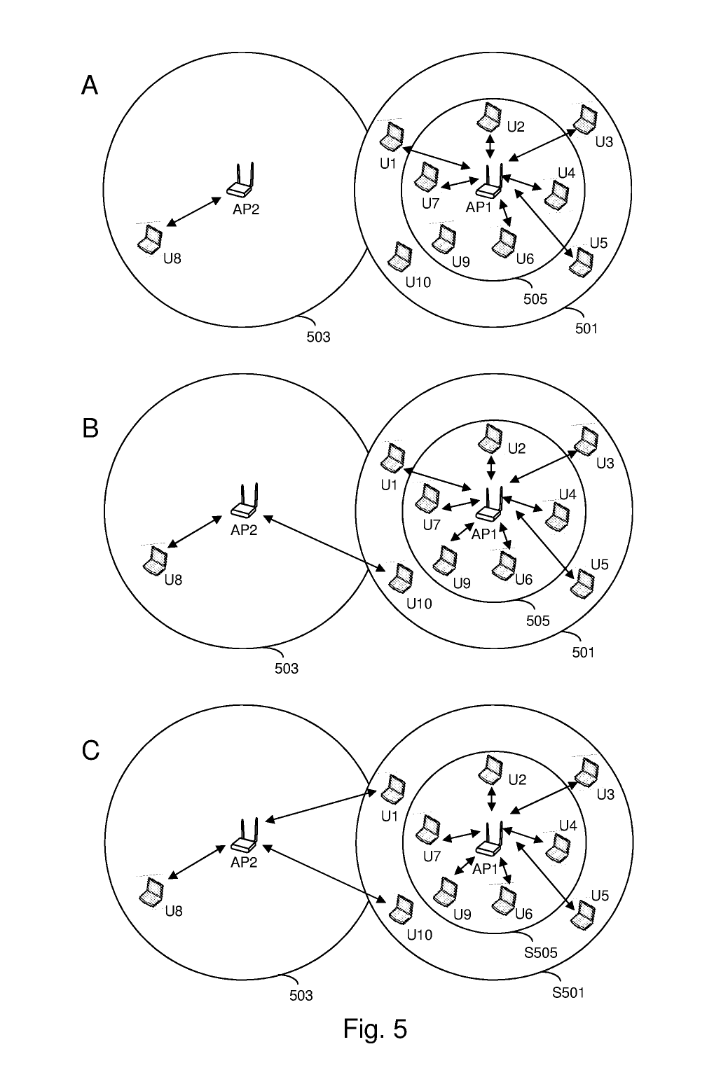

FIG. 5 illustrates an example how user devices may connect to different access points in accordance with embodiments described herein. FIG. 5A shows an example of two access points AP1 and AP2 having respective areas of coverage 501, 503. In FIG. 5A, the access point AP1 is currently serving 7 user devices U1-U7, whilst AP2 is serving 1 user U8. User devices U9 and U10 are new user devices emerging to join the network. The region 505 defines the cell central area for the access point AP1; user devices that are communicating with the access point AP1 and which are outside the area 505 are classified as cell edge users, whilst those inside the area 505 are classified as cell central users.

FIG. 5B shows connections made by the user devices U9 and U10 on joining the network. In line with the embodiment shown in FIG. 3, the new user U9 elects to connect to the network via access point AP1, as it is a cell central user of that access point. The second new user device U10 elects to connect to AP2 since U10 is located outside the cell central area of AP1 and AP1 has a much heavier user load than AP2.

FIG. 5C shows how the other users U1 to U8 that are already connected to the network respond to the changes that result from user devices U9 and U10 joining the network. The user devices U1 to U8 continue to monitor/scan the potential capacity of the access points AP1 and AP2. Since access point AP1 is now serving an additional user device U9, the user devices U1 to U7 may experience a slightly diminished performance from their connection to the access point AP1. In the present example, the user device U1, which is located outside the central area of AP1 now chooses to connect AP2 since it can provide higher capacity.

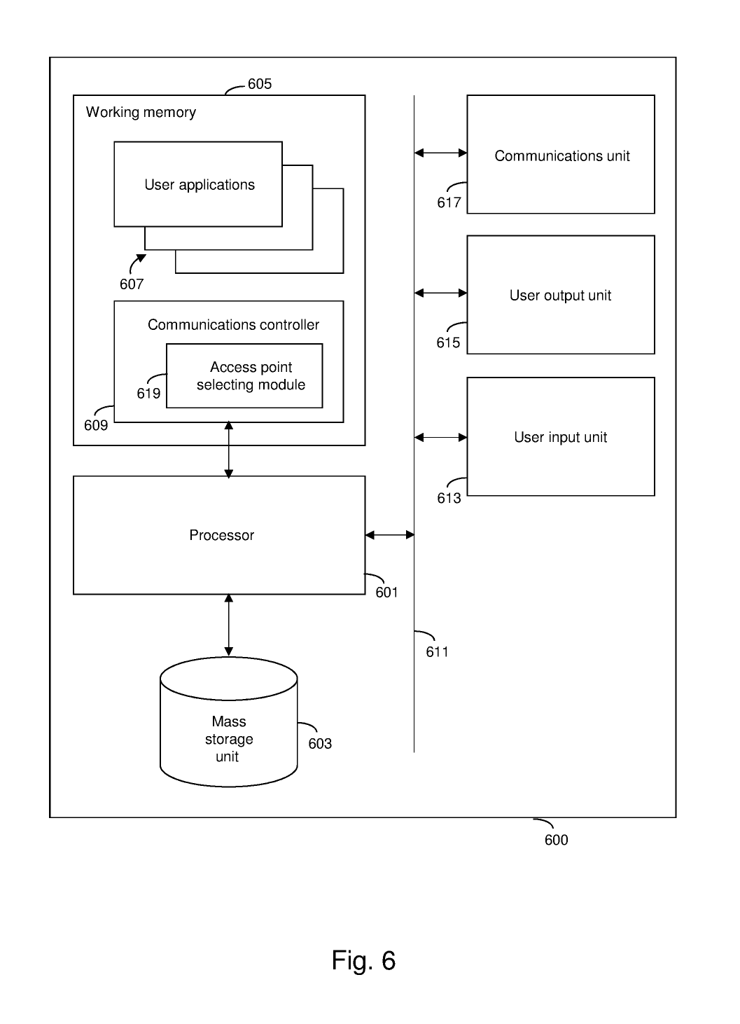

While the reader will appreciate that the above embodiments are applicable to any user device having the capability to connect to a wireless network, a typical user device is illustrated in FIG. 6, which provides means capable of putting an embodiment, as described herein, into effect. As illustrated, the user device 600 comprises a processor 601 coupled to a mass storage unit 603 and accessing a working memory 605. As illustrated, user applications 607 and a communications controller 609 are represented as software products stored in working memory 605. However, it will be appreciated that elements of the user applications 607 and communications controller 609 may, for convenience, be stored in the mass storage unit 603.

Usual procedures for the loading of software into memory and the storage of data in the mass storage unit 603 apply. The processor 601 also accesses, via bus 611, a user input unit 613 and a user output unit 615. A communications unit 617 operates to effect communications with the wireless network. Typically, the communications unit will comprises an antenna that acts as a transmitter and receiver for establishing a communications link with an access point to the wireless network.

The communications controller 609 includes an access point selecting module 619 that is able to select an access point to which the user device should connect, by implementing steps described above in relation to the various embodiments. Thus, execution of the communications controller software 609 by the processor 601 will cause embodiment as described herein to be implemented. The communications controller software 609 can be embedded in original equipment, or can be provided, as a whole or in part, after manufacture. For instance, the communications controller software 609 can be introduced, as a whole, as a computer program product, which may be in the form of a download, or to be introduced via a computer program storage medium, such as an optical disk. Alternatively, modifications to an existing communications controller 609 can be made by an update, or plug-in, to provide features of the above described embodiment.

In embodiments described herein, the load on the different access points can be balanced more effectively and user performance enhanced, since each user will choose to connect to the access point that provides the highest capacity for the user. The system performance as a whole will also be improved, since the majority of the users served by each access point will tend to be cell central users, helping to increase system throughput. In addition, since the method is user-centric, there is minimal change from the perspective of signalling overhead, as the performance optimization can be achieved without the need for inter-access point coordination.

While certain embodiments have been described, these embodiments have been presented by way of example only, and are not intended to limit the scope of the inventions. Indeed, the novel methods and apparatus described herein may be embodied in a variety of other forms; furthermore, various omissions, substitutions and changes in the form of the methods and apparatus described herein may be made without departing from the spirit of the inventions. The accompanying claims and their equivalents are intended to cover such forms or modifications as would fall within the scope and spirit of the invention.

1: A user device comprising:
a receiver for establishing a communications link with a wireless network; and an access point selecting module for selecting an access point to use in establishing the communications link, the access point selecting module being configured to:
(i) identify a plurality of access points within range of the user device;
(ii) for each one of the identified access points:
evaluate the signal to noise ratio achievable by the user device if using the access point to connect to the network;
determine, based on the signal to noise ratio, a maximum rate of data throughput that is achievable if using the access point to connect to the network;
determine the value of a load parameter for the access point, wherein the value of the load parameter is indicative of the apparent demand for resources that the access point is currently experiencing;
determine a relative potential capacity of the access point, wherein the relative potential capacity is determined by weighting the maximum rate of data throughput that is achievable by the load parameter, such that the relative potential capacity increases as the apparent demand for resources decreases; and
(iii) select an access point to connect to the wireless network.

2: A user device according to claim 1, wherein the load paramete a number of user devices connected to the access point.

3: A user device according to claim 1, wherein the load parameter is an interval between receiving successive beacon signals from the access point at the user device.

4: A user device according to claim 1, wherein when selecting an access point to connect to the wireless network, the access point selecting module is configured to identify the access point offering the highest achievable rate of data throughput and the access point having the highest relative potential capacity; and in the event that the access point offering the highest achievable rate of data throughput and the access point having the highest lative potential capacity are the same, to select that access point for connecting to the network.

5: A user device according to claim 1, wherein when selecting an access point to connect to the wireless network, the access point selecting module is configured to identify the access point offering the highest achievable rate of data throughput and the access point having the highest relative potential capacity; and in the event that the access point offering the highest achievable rate of data throughput is different from the access point having the highest relative potential capacity, the access point selecting module is configured to:
determine whether the user device is in an edge region of a cell served by the access point offering the highest achievable rate of data throughput and if so, to select the access point having the highest relative potential for connecting to the network, otherwise to select the access point offering the highest achievable rate of data throughput.

6: A user device according to claim 5, wherein when determining whether the user device is in an edge region of the cell, the access point selecting module is configured to compare the strength of the signal received from the access point offering the highest achievable rate of data throughput with the average signal strength received by user devices currently connected to that access point.

7: A user device according to claim 6, wherein when comparing the strength of the signal received from the access point offering the highest achievable rate of data throughput with the average signal strength received by user devices currently connected to that access point, the user device is configured to first weight the average received signal strength with a threshold parameter, whose value is between 0 and 1.

8: A user device according to claim 1, wherein in the event that the user device is currently connected to the network via a particular access point, the access point selecting module is configured to determine if the particular access point is the same as the access point having the highest relative potential capacity and if so, to select that access point for remaining connected to the network.

9: A user device according to claim 8, wherein in the event that the particular access point to which the user device is currently connected is not the one having the highest relative potential capacity, the user device is configured to determine whether a further switching criterion is met and if so, to switch to the access point having the highest relative potential capacity.

10: A user device according to claim 9, wherein the switching criterion is met when the ratio of the signal strength that the user device is receiving from the access point to which it is currently connected and the average signal strength received by user devices currently connected to that access point is below a threshold.

11: A user device according to claim 10, wherein the threshold is determined by generating a random number.

12: A user device according to claim 1, wherein the user device is configured to repeat steps (i) to (iii) at intervals having a predetermined duration.

13: A user device according to claim 1 , wherein the user device is configured to repeat the steps (i) to (iii) in response to a change in the network environment.

14: A user device according to claim 13, wherein the change the network environment includes a change in the geographic location of the user device and/or a change in the number of user devices connected to the access points that are within range.

15: An access point for facilitating connection of one or more user device(s) to a wireless network, the access point being configured to:
receive a measure of the strength of the signal being received at each user device that it is currently serving;
compute the average strength of the received signals; and
broadcast an indication of the average strength to user devices that are presently within range of the access point.

16: An access point according to claim 15, wherein the access point is further configured to broadcast the number of user devices that it is presently serving to the user devices that are within range.

17: An access point according to claim 15, wherein the access point is configured to broadcast a threshold parameter with value between 0 and 1 and the average strength or to broadcast a
value of the average strength when weighted by the threshold parameter.

18: A system comprising an access point according to claim 16 and one or more user devices, each user device comprising;
a receiver for establishing a communications link with a wireless network; and an access point selecting module for selecting an access point to use in establishing the communications link, the access point selecting module being configured to:
(i) identify a plurality of access points within range of the user device;
(ii) for each one of the identified access points:
evaluate the signal to noise ratio achievable bathe user device if using the access ppint to connect to the network;
determine, based on the signal to noise ratio, a maximum rate of data throughput that is achievable if using the access point to connect o the network;
determine the value of a load parameter for the access point, wherein the value of the load parameter is indicative of the apparent demand for resources that the access point is currently experiencing;
determine a relative potential capacity of the access point, wherein the relative potential capacity is determined by weighting the maximum rate of data throughput that is achievable by the load parameter, such that the relative potential capacity increases as the apparent demand for resources decreases; and
(iii) select an access point to connect to the wireless network.

19: A method for selecting an access point to serve as a connection point for connecting a user device to a wireless network, the method comprising:
(i) identifying a plurality of access points within range of the user device;
(ii) for each one of the identified access points:
evaluating the signal to noise ratio achievable by the user device if using the access point to connect to the network;
determining, based on the signal to noise ratio, a maximum rate of data throughput that is achievable if using the access point to connect to the network;
determining the value of a load parameter for the access point, wherein the value of the load parameter is indicative of the apparent demand for resources that the access point is currently experiencing;
determining a relative potential capacity of the access point, wherein the relative potential capacity is determined by weighting the maximum rate of data throughput that is achievable by the load parameter, such that the relative potential capacity increases as the apparent demand for resources decreases; and
(iii) selecting an access point to connect to the wireless network.

20. A non -transitory computer readable storage medium comprising computer executable instructions that when executed by a computer will cause the computer to carry out a method according to claim 19.
